(19) United States
(12) Patent Application Publication
(10) Pub. No.: US 2009/0037596 A1
(43) Pub. Date: Feb. 5, 2009

(54) MEDIA PERSISTENT RTSP STREAMING

(76) Inventors: Viswanath Math, Santa Clara, CA (US); Ashutosh Malegaonkar, Milpitas, CA (US); Prasad Miriyala, Union City, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/832,545

(22) Filed: Aug. 1, 2007

(51) Int. Cl. G06F 15/16

(52) U.S. Cl. 709/231

(57) ABSTRACT

In one example embodiment, a method includes receiving at a server during a first media file streaming session to a user over a network a request from the user to pause streaming the media file at a selected time stamp point in the file. The server receives a request from the user to suspend the session. The server stores information in a memory information corresponding to the suspended streaming of the media file based on the request to suspend. The server may also resume streaming the media file to the user in a second media file streaming session from the specified streaming suspension point.

### TECHNICAL FIELD

The present disclosure relates generally to the control of streaming media sessions.

### BACKGROUND

Real Time Streaming Protocol (RTSP) is a protocol for use in streaming media systems which allows a client (for example, a software application on a terminal device) to remotely control a streaming media server, issuing VCR-like commands such as “play” and “pause”.

### BRIEF DESCRIPTION OF THE DRAWINGS

The present invention will be understood more fully from the detailed description that follows and from the accompanying drawings, which however, should not be taken to limit the invention to the specific embodiments shown, but are only for explanation and understanding.

FIG. 1 is an overview of elements of a method of media persistent Real Time Streaming Protocol in accordance with an example embodiment of the disclosure.

FIG. 2 is an overview of a method of streaming, suspending and resuming streaming, in accordance with an example embodiment of the disclosure.

FIG. 3 is a script for initiating a media streaming session, in accordance with one example embodiment of the disclosure.

FIG. 4 is a script for suspending a media streaming session, in accordance with one example embodiment of the disclosure.

FIG. 5 is a script for resuming a media streaming session, in accordance with one example embodiment of the disclosure.

FIG. 6 illustrates a graphical user interface including media streaming RTSP options, in accordance with one example of the disclosure.

FIG. 7 illustrates a system for providing media persistent RTSP in a media streaming session, in accordance with one example embodiment of the disclosure.

### DESCRIPTION

### Overview

According to one example embodiment, a method of managing a session from a server of media file streaming includes receiving a request to end a session of streaming a media file to a user over a network. The streaming media file transmission is suspended at a specified point in the media file. Information corresponding to the suspended transmission of the steaming media file is stored by the server. At a later time the streaming media file transmission via the server is resumed from the specified point.

### DESCRIPTION OF EXAMPLE EMBODIMENTS

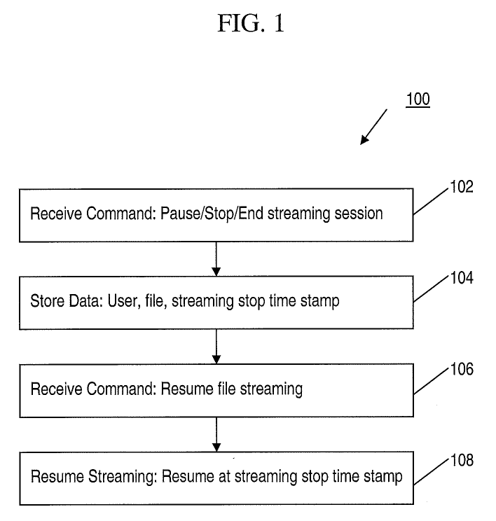

In one example embodiment of the disclosure, FIG. 1 shows a method 100 of “media persistent” Real Time Streaming Protocol (RTSP). In this example embodiment, media persistent RTSP may handle suspension of streaming media files and maintaining a persistent record corresponding to the user, the file, and the time stamp location point of suspension, where the persistent record enables a user to continue streaming the media file from the same point in the file at which it was last suspended. Examples of streaming media files include, but are not limited to, movies, recorded broadcasts, audio, slide, and lecture presentations. Streaming media may be defined as multimedia that is continuously received by, and normally displayed to, the end-user while it is being delivered by the provider. A streaming media session may be defined as an interval during which the end-user is in communication with the provider, via a network, for example, but not limited thereto, and receiving the multimedia. The user may receive the file on a terminal or other suitable output device. Examples of terminals may include a network enabled personal computer, personal digital assistant, cell phone, and any other terminal device suitable for a file streaming process. The file is made available to the user on the terminal via a streaming media player software application operable on the terminal, referred to as a client. For example, in one embodiment, a student user may wish to view a recorded course lecture online by requesting the lecture media file. The user may find it necessary to suspend the lecture presentation and resume at another time. Method 100 enables the user to continue from the same point in the lecture during a subsequent streaming session. This embodiment is not limiting, and it should be understood that the invention can be practiced with modification and alteration.

Referring now to FIG. 1, during a media file streaming session, a server receives, at block 102, a series of commands that results in ending the session, either temporarily or permanently. Examples of commands include pause, stop, and end. The commands can be transmitted by a user viewing, listening, or otherwise accessing the streaming session, through any suitable means, such as a terminal. The server responds to the user command by storing, at block 104, data related to the session, e.g., the user ID, the file ID, and a time stamp that identifies where in the file the streaming was stopped, paused, or ended, such as in an associated memory. At a later time, the user, who may have moved to a new location, may want to resume the streaming session at the previous stop point. If so, the user transmits a command, which the server receives, at block 106, to resume streaming the file. The server then correlates the user ID, the file ID, and/or any other relevant information and retrieves the related record to determine the time stamp at which the file was paused or stopped. A command option is then provided to the user to resume streaming, at block 108, from the time stamp. Once the user selects the option, which may be a simple “resume” option, the server streams the session at that point. It should be apparent that method 100 operates in cooperative association with standard RTSP commands.

Method 100 may be regarded as a server function, i.e., as a method executed and provided by a server. Method 100 may be a separate process that runs concurrently or in association with other server processes. The server may be regarded as an executable program running on a dedicated processor from a memory associated with the processor, where the server provides transactional support between systems and users that may be spread across a network. In other embodiments, the server may be regarded as a processor running executable program applications, including method 100, which provides transactional support between systems and users.

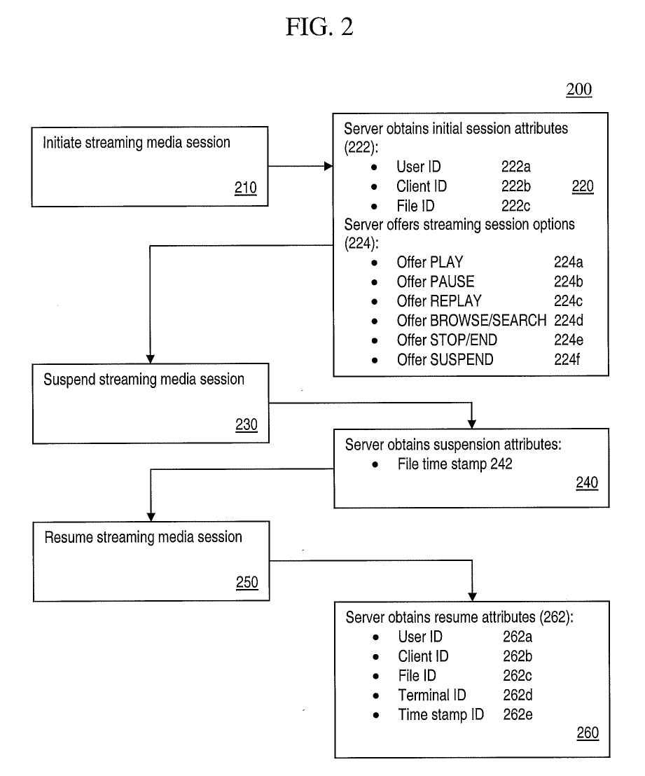

FIG. 2 illustrates one example embodiment of a method 200 of initiating, stopping, and resuming media file streaming in two or more separate and successive sessions, where both standard RTSP and media persistent RTSP method 100 may be implemented. In the following example, it is assumed that a session is set up by a user at a terminal using a media player client. Conventional RTSP message exchanges may be used between the user and server to set up the session and commence file streaming. RTSP management may be provided by the server or a server related apparatus, and the term “server” may apply to either or both. In this example, the user first initiates the reception of a streaming media file in block 210. This can be with an application referred to as a streaming media client or a media player client via RTSP such as, for example, by logging on to the network, navigating to the website (which may be hosted on the server or connected to the server over a network) that offers access to the media file, satisfying access requirements (e.g., User ID, password, account information, etc.), and identifying the file. File identification can then proceed as follows: From the server, conventional RTSP presents a DESCRIBE request, which includes an RTSP URL (e.g., “rtsp:// . . . ”), and the type of reply data that can be handled. The reply includes the presentation description. In the process of receiving the user request to initiate a streaming session, the server acquires several attributes, as described below.

Once initiated, session attributes 222 are obtained, and streaming session options 224 are presented to the user in block 220. For example, a user ID 222a, a client ID 222b, and/or a file ID 222c can be obtained and stored. In addition, the server may provide the user with various options for the media file or session presented through a graphical user interface (GUI) of the media player client, such as “PLAY” 224a, “PAUSE” 224b, “REPLAY” 224c, “BROWSE/SEARCH” 224d, “STOP/END” 224e, and “SUSPEND” 224f. Typically, the user selects the PLAY option to establish the session and initiate playback of the streamed media file.

Once the session is established, the user may at some point decide to suspend the session instead of sending a teardown request (i.e., “teardown” is a standard RTSP request to terminate the session, stopping all media streams and freeing all session related data on the server) and departing from the terminal. The user may, for example, press a soft key button named “SUSPEND” provided in the GUI of the client application playing the file to suspend, in block 230, file streaming or the session. “SUSPEND” is not a standard RTSP request, but is a feature of media persistent RTSP. The SUSPEND command indicates to the server that it should retain the time stamp in block 240, or other marking information, at which time the streaming media file is paused/stopped together with the file and user identity. Therefore, the server will create and store a persistent object, whose attributes include at least the time stamp where the media was suspended, the reference to the media (e.g., file identification or file ID 222c), and a reference to the user (user identification, or user ID 222a). This persistent object may be stored in the server associated memory. Thus, it may be apparent that media persistent RTSP is capable if interdicting a full teardown in order to maintain certain session related data, as described earlier.

After suspending the current media file, the user may continue at the same terminal or move to a different media player client and/or terminal at a later time to view the same content contained in the streaming media file. The user may wish to continue viewing the media file from the last stopping point (i.e., where “SUSPEND” was requested) or elsewhere in the file. The user may initiate a session in the normal way, e.g., via RTSP and contact with the server, providing user identification using known protocols and processes, such as follows: RTSP presents a DESCRIBE request, which is a request to specify a URL (e.g., “rtsp:// . . . ”), and the type of reply data that can be handled. The reply is then returned from the server, which is configured to provide media persistent RTSP services (as described above), where the reply may include the media file description, and may contain information about whether the media session was suspended or whether new media is being requested. Based on this reply, the server may provide to the client, for example, through a GUI selection of soft button, options which may include “START”, “STOP”, “START OVER AGAIN”, “RESUME”, “NEW FILE”, or substantial equivalents. Alternatively, for example, separate pop-up windows may be generated by the server if the client is not adapted to provide the soft buttons corresponding to the added functionality. If the user indicates the choice to “RESUME”, the content will continue, in block 250, from the point where the user left off during the previous instantiation of the session corresponding to the time stamp information retained by the server.

The server retrieves “resume” attributes 262, in block 260, obtained during the earlier sessions, where the resume attributes are information related to resuming playback of the media file. For example, resume attributes 262 may include a user ID 262a, a client ID 262b, a file ID 262c, a terminal ID 262d, and/or a time stamp ID 262e. Using resume attributes 262, the server resumes playback of the media file to the user at the point of the media where the user suspended play even at a different media client. This is possible because the server stores information needed to resume playback, which is accessible to the user when using a different media player client. The stored information may be retained in the server and/or server-related memory apparatus for a specified length of time that may be related to limitations of memory storage space on the server side of the network. Alternatively, the information may be stored indefinitely if adequate storage memory is provided. For example, the information may be stored for up to a week, longer, or indefinitely. The information may be automatically deleted after the specified length of time, where the specified length of time may be a system default or user selectable.

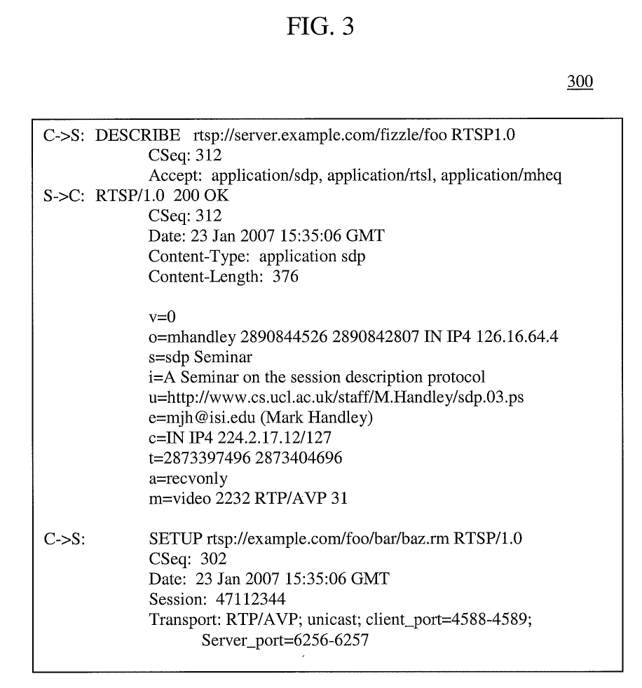

FIG. 3 is an example embodiment of a script 300 illustrative of an example interaction between the user and the server that may be used in initiating a session in block 210 and block 220 of FIG. 2. The DESCRIBE message is used to retrieve information about the particular presentation, which consists of one or more underlying streams (e.g., audio and/or video). The reply in this example specifies a Session Description Protocol (SDP), which is a format for describing streaming media initialization parameters. The SETUP request is used to negotiate the transport parameters, including the real-time transport protocol (RTP) and the Transmission Control Protocol/User Datagram Protocol (TCP/UDP) port numbers. Upon receiving the client SETUP message, port numbers are generated for the connections, and a session identifier is selected. The port numbers and session identifier are sent to the client. The client can send the PLAY message after receiving the response to the SETUP request and initiate the streaming of RTP and RTSP messages to the client. The client can begin playback, whereupon data transport proceeds. It may be apparent from the above, that up to this point, standard RTSP commands are implemented.

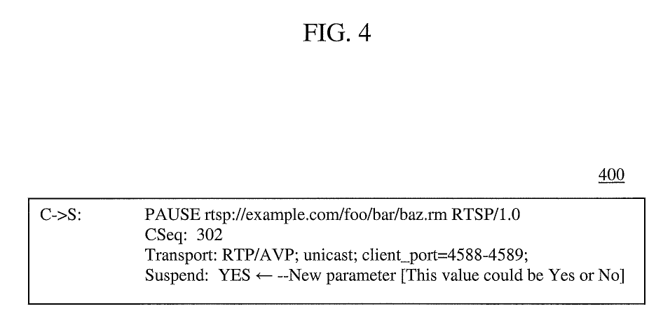

FIG. 4 is an example embodiment of a script 400 illustrative of the interaction between the user and the server that may be used in suspending a media streaming session in block 230 and block 240 of FIG. 2. Suspension begins with a PAUSE request. A PAUSE request temporarily halts one or all media streams, which can later be resumed with a PLAY request. Transport to the client port is also halted. This is followed by a new request option: SUSPEND. The reply may be either YES or NO. If the reply is YES, the server then retains a record of the user, file, and time stamp at which play was paused. Standard protocol commands are then used to end the session.

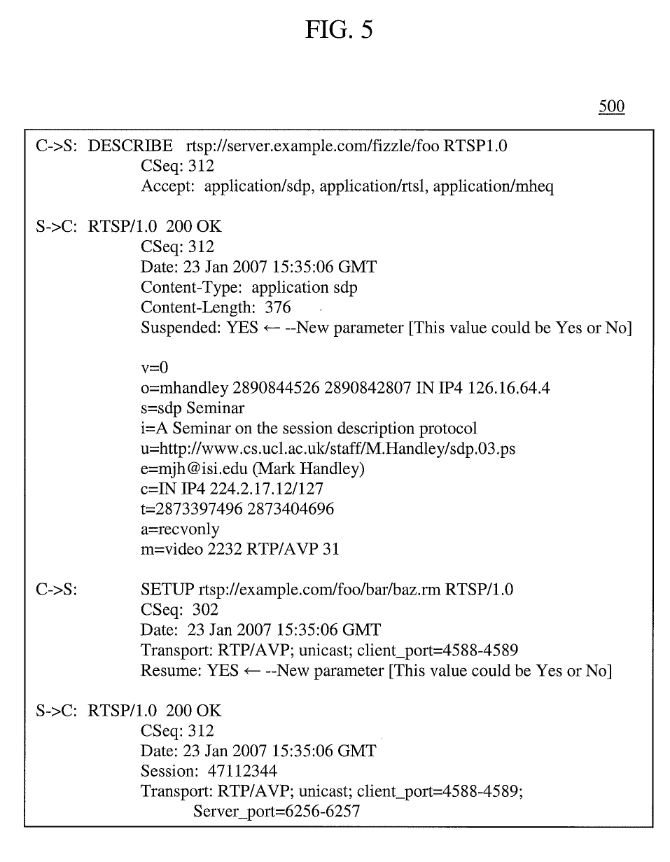

FIG. 5 is an example embodiment of a script 500 illustrative of an example interaction between the user and the server that may be used to resume a media streaming session in block 250 and block 260 of FIG. 2. Initiating the continuation session begins in the same way as described in FIG. 3 for initiating a new session. However, a new request option, FILE SUSPENDED, is provided. The reply may be either YES or NO. If the reply is YES, then the server links the user to the suspended file, and transport of the stream is re-established, subject to user selection of appropriate commands, such as RESUME, which may have a reply option of YES or NO. If the reply is YES, transport of the media stream between the server port and the client port is established, and the streaming continues from the time stamp point at which suspension took place.

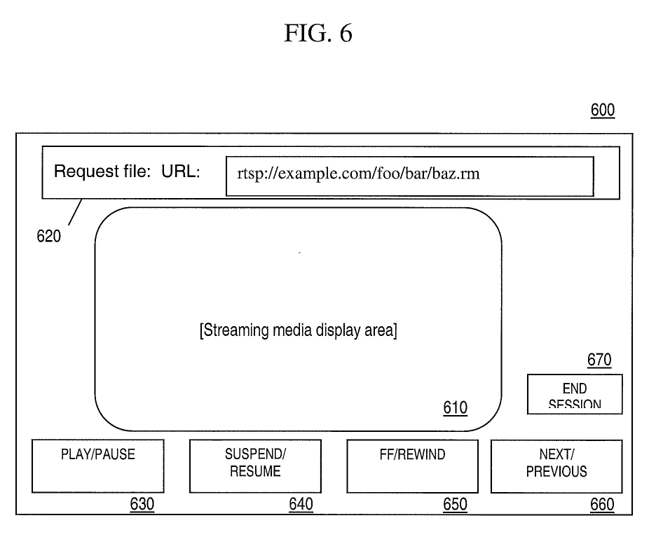

FIG. 6 illustrates one example embodiment of a graphical user interface (GUI) 600 including new command options provided by the server. The client terminal screen, using a media player application, may appear as the GUI 600. A streaming media display area 610 may be positioned on the display for viewing if the media contains video. An audio signal may be provided at speakers and/or an audio jack. Accessing a file may be done by entering a URL address associated with the file in a Request File Box 620. Once the server and client are connected and file data transport is enabled, the user may PLAY or PAUSE the streaming media file by toggling a PLAY/PAUSE soft key 630. New command options are offered to control the streaming media session. For example, a SUSPEND/RESUME soft key 640 is provided to halt the session at any point or to resume it at any time, and particularly in a different session and/or from a different client. Additionally, other standard soft keys may be provided, such as a FAST FORWARD/REWIND (FF/REWIND) key 650, a NEXT/PREVIOUS key 660 (for file or chapter selection, for example), and an END SESSION key 670. These keys are be pressed to select or toggle to select functions as described above.

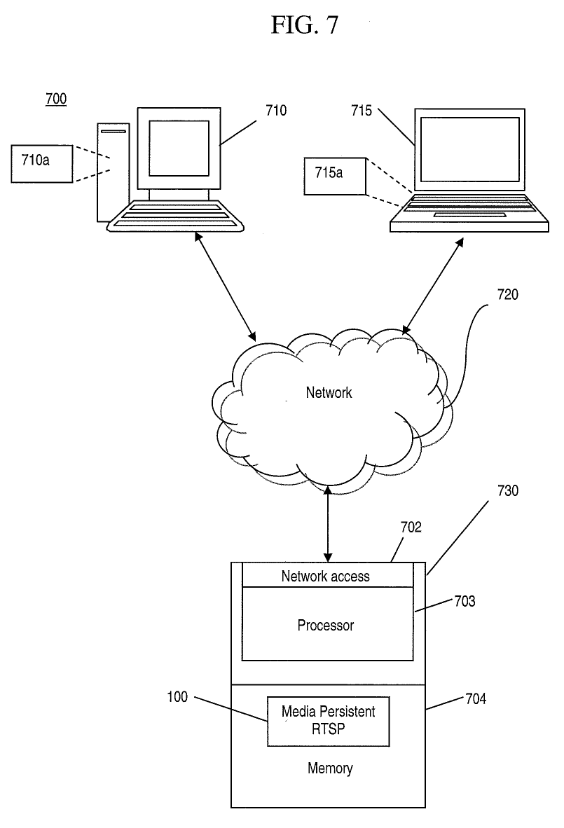

FIG. 7 shows an example embodiment of a system for streaming media using media persistent RTSP method 100. System 700 includes a first terminal 710 configured to operate a streaming media client 710a and at least a second terminal 715 configured to operate a streaming media client 715a. The two terminals may be the same or different terminals, and clients 710a and 715a may be the same or different. Terminals 710 and 715 communicate over a network 720 with a server 730. Network 730 may be, for example, the Internet, a wide area network (WAN), a local area network (LAN), or an equivalent. Server 730 is configured to operate media persistent RTSP method 100 protocols as discussed above.

Server 730 may also include network connection means 702, such as one or more antennas, ports, or other suitable communication means. Server 730 may also include a memory 704 within or coupled to a processor 703 of server 730 for storing instructions or results, such as information corresponding to a suspended streaming media session as described above (e.g., Media Persistent RTSP method 100). Memory 704 stores instructions operable by processor 703, such that when processor 703 executes the instructions, media persistent RTSP method 100 may be performed. The connection means, processor and memory are conventional and thus are not described in any more detail. Those skilled in the art will appreciate and understand the various types and implementations of the connection means, processor and memory.

A system for providing transactions that enable a user presently receiving a streaming media file in a session to suspend the streaming and continue it from the same point in a later session comprises a server coupled to a network. In one example embodiment, through this server the user communicates with the file server supplying the media file being streamed. The server may access to the network through a modem. The server has access to the file server supplying the file over a network which may be the same network or another network to which the server couples via a modem. The server has access to a storage memory. When the user wishes to suspend the streaming and end the session, the server places in the memory a record relating to the session that includes at least the identity of the user, the file, the file location, and a time stamp identifying the location of the stopping point in the file when streaming was paused. When the user initiates a subsequent session, and requests resumption of streaming of the same file, the server accesses the memory and enables a transaction where the user may continue streaming from the suspension point, based on the stored information.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention only be limited by the claims and the equivalents thereof.

What is claimed is:

1. A method comprising:
receiving, during a first streaming session of a media file over a network, a request to suspend the first streaming session at a selected time;
storing information corresponding to the suspended first streaming session based on the request to suspend;
receiving a request to resume streaming of the media file; and
resuming streaming the media file in a second streaming session from the selected time.

2. The method of claim 1, wherein the first streaming session is to a first user and the resuming is to a second user.

3. The method of claim 2, wherein the first and second users are the same.

4. The method of claim 1, wherein the request to suspend is different from a request to end a session.

5. The method of claim 1, wherein the storing is at a server.

6. The method of claim 1, wherein the information comprises a persistent record, the media file, and the selected time.

7. The method of claim 6, wherein the first streaming session ends after the persistent record is stored.

8. The method of claim 6, wherein the persistent record comprises a user ID, a client ID, and a file ID.

9. The method of claim 1, wherein the first session is initiated by a user at a first terminal, and the second session is initiated by the user at a second terminal.

10. The method of claim 9, wherein the first and second terminals are the same terminal.

11. The method of claim 9, wherein the first terminal receives the streaming media file with a first streaming media player client, and the second terminal receives the streaming media file with a second streaming media player client.

12. The method of claim 11, wherein the first and second clients are the same client.

13. The method of claim 1, further comprising initiating the first streaming session.

14. The method of claim 13, wherein the initiating comprises:
storing initial attributes of the first streaming session; and
transmitting a set of commands to the first user.

15. The method of claim 14, wherein the set of commands comprises a play function, a suspend function, and a resume function.

16. An apparatus comprising:
one or more processors; and
a memory coupled to one or more of the processors comprising instructions executable by one or more of the processors, one or more of the processors operable when executing the instructions to:
receive signals from and transmit signals to users, wherein the signals comprise a first session for streaming a media file;
receive a first request to suspend the streaming media file session;
suspend the streaming media file session at a selected time based on the first request;
store information corresponding to the suspended streaming session based on the first request;
receive a second request to resume the streaming session; and
resume the media file streaming in a second streaming session at the selected time.

17. The apparatus of claim 16, wherein the information comprises a user identity, a file identity, a file location, and a time stamp corresponding to the selected time.

18. The apparatus of claim 16, wherein the information is stored for a selected length of time.

19. The apparatus of claim 18, where the selected length of time is one week or less.

20. The apparatus of claim 16, wherein the first streaming session is to a first user and the resumed streaming in a second session is to a second user.

21. The apparatus of claim 20, wherein the first and second users are the same.

22. The apparatus of claim 14, further comprising a graphical user interface, wherein the graphical user interface comprises a user-selectable suspend function, a resume function, or a suspend-and-resume function.

23. A method comprising:
initiating a first streaming session of a media file over a network;
suspending the first streaming session upon receiving a request to pause playback of the media file;
storing information corresponding to the suspended first streaming session; and
resuming streaming the media file in a second streaming session from the selected time upon receiving a request from a second user to resume playback of the media file.

24. The method of claim 23, wherein the initiating is to a first user, the request is from the first user, and the resuming is to a second user.

25. The method of claim 24, wherein the first and second users are the same.
